(19) United States
(12) Patent Application Publication
(10) Pub. No.: US 2018/0267538 A1
(43) Pub. Date: Sep. 20, 2018

(54) Log-Based Vehicle Control System Verification

(71) Applicant: TOYOTA JIDOSHA KABUSHIKI KAISHA, Toyota-shi (JP)

(72) Inventors: Jonathan Shum, Mountain View, CA (US); BaekGyu Kim, Mountain View, CA (US); Shinichi Shiraishi, Mountain View, CA (US)

(21) Appl. No.: 15/459,903

(22) Filed: Mar. 15, 2017

(51) Int. Cl. G05D 1/00; G06F 17/50; B60W 30/09

(52) U.S. Cl. CPC G05D 1/0088; B60W 30/09; G06F 17/5009

(57) ABSTRACT

The disclosure includes embodiments for improving the performance of a set of Advanced Driver Assistance Systems (“ADAS systems”) included in a vehicle design for a Highly Autonomous Vehicle (“HAV”). A method includes generating simulation data. The method includes providing the simulation data, vehicle model data and ADAS model data as inputs to a simulation application. The method includes executing the simulation application based on the inputs to provide a set of simulations which are configured to test one or more variations for the set of ADAS systems included in the vehicle design in one or more simulated driving scenarios. The method includes analyzing the operation of the different variations for the set of ADAS systems in the set of simulations to automatically generate review data that quantitatively describes one or more areas for improving the operation of the set of ADAS systems included in the vehicle design.

### BACKGROUND

The specification relates to a log-based system for providing verification of vehicle control systems.

Vehicle control systems are becoming increasingly popular. One example of a vehicle control system is an Advanced Driver Assistance System (“ADAS system” if singular, “ADAS systems” if plural).

ADAS systems provide one or more autonomous features to the vehicles which include these ADAS systems. For example, an ADAS system may monitor the position of a vehicle relative to the lane in which the vehicle is traveling, and if the vehicle begins to swerve outside of that lane the ADAS system may take remedial action by repositioning the vehicle so that the vehicle stays in the lane or providing a notification to a driver of the vehicle so that the driver knows that they need to take action to remedy the situation.

### SUMMARY

Consumers are interested in vehicles with the best autonomous features. Engineers who design ADAS systems would like access to quantitative data that provides with insight into ways to improve the performance of their ADAS systems so that the autonomous features provided by these ADAS systems may meet or exceed consumer's expectations.

Some vehicles have “a set of ADAS systems” that provide a sufficient combination and quality of autonomous features that these vehicles are considered to be “autonomous vehicles.” The set of ADAS systems includes one or more ADAS systems that provide one or more autonomous features for a vehicle.

The National Highway Traffic Safety Administration (“NHTSA”) has defined different “levels” of autonomous vehicles, e.g., Level 0, Level 1, Level 2, Level 3, Level 4 and Level 5. If a vehicle has a higher level number than another vehicle (e.g., Level 3 is a higher level number than Levels 2 or 1), then the vehicle with a higher level number offers a greater combination and quantity of autonomous features relative to the vehicle with the lower level number. The different levels of autonomous vehicles are described briefly below.

Level 0: The set of ADAS systems installed in the vehicle have no vehicle control, but may issue warnings to the driver of the vehicle.

Level 1: The driver must be ready to take control at any time. The set of ADAS systems installed in the vehicle may provide autonomous features such as one or more of the following: Adaptive Cruise Control (“ACC”); and Parking Assistance with automated steering and Lane Keeping Assistance (“LKA”) Type II, in any combination.

Level 2: The driver is obliged to detect objects and events in the roadway environment and respond if the set of ADAS systems installed in the vehicle fail to respond properly (based on the driver's subjective judgment). The set of ADAS systems installed in the vehicle executes accelerating, braking, and steering. The set of ADAS systems installed in the vehicle can deactivate immediately upon takeover by the driver.

Level 3: Within known, limited environments (such as freeways), the driver can safely turn their attention away from driving tasks, but must still be prepared to take control of the vehicle when needed.

Level 4: The set of ADAS systems installed in the vehicle can control the vehicle in all but a few environments such as severe weather. The driver must enable the automated system (which is comprised of the set of ADAS systems installed in the vehicle) only when it is safe to do so. When the automated system is enabled, driver attention is not required for the vehicle to operate safely and consistent with accepted norms.

Level 5: Other than setting the destination and starting the system, no human intervention is required. The automated system can drive to any location where it is legal to drive and make its own decision (which may vary based on the jurisdiction where the vehicle is located).

Currently, there is no accepted quantitative standard to compare and contrast the performance of ADAS systems above Level 2 (e.g., Levels 3-5), and as a result, the engineers who design ADAS systems that provide autonomous features that are greater than Level 2 do not have a standardized way to quantitatively identify areas of improvement for ADAS systems that provide autonomous features above Level 2.

Described are embodiments that include a system, method and a computer program product for generating data which enables engineers to quantitatively identify areas for improving the performance of ADAS systems that provide autonomous features that are above Level 2.

Described below are embodiments which include a reconstruction client of a real-world vehicle which wirelessly communicates with a reconstruction module of a server.

In some embodiments, the vehicle travels on a real-world roadway. The vehicle is a real-world vehicle that includes one or more of the following elements: a set of sensors (“a sensor set” including one or more onboard vehicle sensors); an onboard vehicle computer; a non-transitory memory; the reconfiguration client; a set of ADAS systems (which provides autonomous features greater than Level 2); a global positioning system unit (“GPS unit”) that is compliant with the Dedicated Short Range Communication (“DSRC”) standard; and a communication unit. A GPS unit which is compliant with the DSRC standard is referred to herein as a “DSRC-compliant GPS unit.”

In some embodiments, the DSRC standard includes one or more of the following: EN ISO 14906:2004 Electronic Fee Collection—Application interface EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); and EN 13372:2004 Dedicated Short-Range Communication (DSRC)—DSRC profiles for RTTT applications (review).

In some embodiments, the reconstruction client includes code and routines that are operable, when executed by a processor of the vehicle (e.g., the onboard vehicle computer), to cause the processor to: (1) active one or more of the sensors of the and cause them to collect sensor data describing real-world driving scenarios and how the set of ADAS systems responded to these real-world driving scenarios; (2) cause the DSRC-compliant GPS unit to retrieve GPS data tags for each instance of sensor data; (3) associate each GPS data tag with each instance of sensor data so that the geographic location associated with (or described by) each instance of sensor data is known; build a sensor data log which includes the sensor data and the associated GPS data tags; (4) store the sensor data log on the non-transitory memory; and (5) cause the communication unit to wirelessly transmit the sensor data log to the reconstruction module via a wireless network. The wireless transmission of the sensor data log may occur on a periodic or predetermined basis. The sensor data log may optionally be deleted after it is transmitted to improve the availability of storage space on the non-transitory memory.

The server includes a simulation application and a reconstruction module. The simulation application generates simulations for testing virtual vehicles and the performance of their virtualized set of ADAS systems. These simulations are generated based on simulation data which is generated by the reconstruction module.

In some embodiments, the reconstruction module includes code and routines that are operable, when executed by a processor of the server, to cause the processor: (1) analyze the sensor data log; and (2) generate the simulation data so that it is operable to cause the simulation application recreate the real-world driving scenarios described by the sensor data log and observed by the vehicle sensors of the real-world vehicle.

The server includes a non-transitory memory that stores the simulation data, vehicle model data and ADAS model data. The vehicle model data describes a vehicle model for the real-world vehicle associated with the sensor data log. The ADAS model data describes a set of models for one or more virtual ADAS systems (which provide autonomous features greater than Level 2) that are different than, or tuned differently than, the set of ADAS systems present on the real-world vehicle that provided the sensor data log (and whose operation is in part described by the sensor data log).

In some embodiments, a reconstruction module includes code and routines that are operable, when executed by a processor, to cause the processor to quantify performance and reliability of various ADAS systems under driving scenarios using simulations which are generated based on sensor data logs that describe real-world driving scenarios.

For example, the reconstruction module includes code and routines that are operable, when executed by a processor of the server, to cause the processor to: (1) provide the simulation data, the vehicle model data and the ADAS model data as an input to the simulation application; (2) execute the simulation application using the inputs to provide a set of simulations that test the operation of different virtual ADAS systems (or different tuning configurations for different virtual ADAS systems) as described by the ADAS model data; (3) generate execution data that quantitatively describes the operation of the virtual version of the vehicle, and the different virtual ADAS systems of the virtual version of the vehicle, within a simulated roadway environment which is modeled to include the same roadway, static objects and dynamic objects which the real-world vehicle experienced as described by the sensor data log; and (4) analyze the execution data and the sensor data log (which was used to generate the simulation data) to generate review data that quantitatively describes one or more opportunities for improving the performance of the real-world set of ADAS systems based on the performance of the real-world set of ADAS systems relative to the virtual ADAS systems whose performance was measured by the set of simulations and described by the execution data.

In some embodiments, the reconstruction module is a plugin for an existing simulation application. In some embodiments, the reconstruction module is a standalone simulation application that is designed from the ground up to include the functionality of the reconstruction module.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for improving a performance of a set of ADAS systems included in a vehicle design for a highly autonomous vehicle (“HAV”), the method including: generating simulation data based on a sensor data log generated by the HAV; providing the simulation data, vehicle model data and ADAS model data as inputs to a simulation application, where the vehicle model data describes the vehicle design for the HAV and the ADAS model data describes one or more variations for the set of ADAS systems included in the vehicle design for the HAV; executing, by a processor, the simulation application based on the inputs to provide a set of simulations which are configured to test the one or more variations for the set of ADAS systems included in the vehicle design for the HAV in one or more realistic driving scenarios which are described by the sensor data log, where each simulation included in the set of simulations tests a different variation for the set of ADAS systems; analyzing, by the processor, operation of the different variations for the set of ADAS systems in the set of simulations to automatically generate, without an input to do so, review data that quantitatively describes one or more areas for improving the operation of the set of ADAS systems included in the vehicle design for the HAV; and outputting a graphical user interface that displays the review data. Other embodiments of this aspect include corresponding computer systems, apparatus, and computer programs recorded on one or more computer storage devices, each configured to perform the actions of the methods.

Implementations may include one or more of the following features. The method where the sensor data log includes one or more measurements recorded by an onboard sensor of the HAV. The method where the sensor data log describes a relative position of the HAV and one or more objects within a real-world roadway environment that includes the HAV. The method where the sensor data log describes an operation of the set of ADAS systems in response to one or more objects within a real-world driving scenario experienced by the HAV, where the set of ADAS systems are included in the vehicle design such that they are present in the HAV during the real-world driving scenario. The method where the set of simulations virtually recreate the real-world driving scenario so that an operation of the one or more variations for the set of ADAS systems is determined and measured by the set of simulations. The method where the review data quantitatively describes the operation of the set of ADAS systems that are present in the HAV during the real-world driving scenario relative to the operation of the one or more variations for the set of ADAS systems included in the vehicle design for the HAV. The method where the driving scenarios included in the set of simulations are realistic because they substantially recreate the real-world driving scenario which is described by the sensor data log. The method further including analyzing the set of simulations to ensure that the driving scenarios included in the set of simulations substantially recreate the real-world driving scenario described by the sensor data log. Implementations of the described techniques may include hardware, a method or process, or computer software on a computer-accessible medium.

One general aspect includes a system for improving a performance of a set of ADAS systems included in a vehicle design for an HAV, the system including: a processor; and a non-transitory memory storing computer code which is operable, when executed by the processor, to cause the processor to perform steps including: generating simulation data based on a sensor data log generated by the HAV; providing the simulation data, vehicle model data and ADAS model data as inputs to a simulation application, where the vehicle model data describes a vehicle design for the HAV and the ADAS model data describes one or more variations for the set of ADAS systems included in the vehicle design for the HAV; executing the simulation application based on the inputs to provide a set of simulations which are configured to test the one or more variations for the set of ADAS systems included in the vehicle design for the HAV in one or more realistic driving scenarios which are described by the sensor data log, where each simulation included in the set of simulations tests a different variation for the set of ADAS systems; and analyzing operation of the different variations for the set of ADAS systems in the set of simulations to automatically generate review data that quantitatively describes one or more areas for improving the operation of the set of ADAS systems included in the vehicle design for the HAV. Other embodiments of this aspect include corresponding computer systems, apparatus, and computer programs recorded on one or more computer storage devices, each configured to perform the actions of the methods.

Implementations may include one or more of the following features. The system where the sensor data log includes one or more measurements recorded by an onboard sensor of the HAV. The system where the sensor data log describes a relative position of the HAV and one or more objects within a real-world roadway environment that includes the HAV. The system where the sensor data log describes an operation of the set of ADAS systems in response to one or more objects within a real-world driving scenario experienced by the HAV, where the set of ADAS systems are included in the vehicle design such that they are present in the HAV during the real-world driving scenario. The system where set of simulations virtually recreate the real-world driving scenario so that an operation of the one or more variations for the set of ADAS systems is determined and measured by the set of simulations. The system where the review data quantitatively describes the operation of the set of ADAS systems that are present in the HAV during the real-world driving scenario relative to the operation of the one or more variations for the set of ADAS systems included in the vehicle design for the HAV. The system where the driving scenarios included in the set of simulations are realistic because they substantially recreate the real-world driving scenario which is described by the sensor data log. The system further including analyzing the set of simulations to ensure that the driving scenarios included in the set of simulations substantially recreate the real-world driving scenario described by the sensor data log. Implementations of the described techniques may include hardware, a method or process, or computer software on a computer-accessible medium.

One general aspect includes a computer program product for improving a performance of a set of ADAS systems included in a vehicle design for an HAV, the computer program product including a non-transitory memory storing computer-executable code that, when executed by a processor, causes the processor to: generate simulation data based on a sensor data log generated by a HAV; provide the simulation data, vehicle model data and ADAS model data as inputs to a simulation application, where the vehicle model data describes a vehicle design for the HAV and the ADAS model data describes one or more variations for the set of ADAS systems included in the vehicle design for the HAV; execute the simulation application based on the inputs to provide a set of simulations which are configured to test the one or more variations for the set of ADAS systems included in the vehicle design for the HAV in one or more realistic driving scenarios which are described by the sensor data log, where each simulation included in the set of simulations tests a different variation for the set of ADAS systems; and analyze operation of the different variations for the set of ADAS systems in the set of simulations to automatically generate review data that quantitatively describes one or more areas for improving the operation of the set of ADAS systems included in the vehicle design for the HAV. Other embodiments of this aspect include corresponding computer systems, apparatus, and computer programs recorded on one or more computer storage devices, each configured to perform the actions of the methods.

Implementations may include one or more of the following features. The computer program product where the sensor data log includes one or more measurements recorded by an onboard sensor of the HAV. The computer program product where the sensor data log describes a relative position of the HAV and one or more objects within a real-world roadway environment that includes the HAV. The computer program product where the sensor data log describes an operation of the set of ADAS systems in response to one or more objects within a real-world driving scenario experienced by the HAV, where the set of ADAS systems are included in the vehicle design such that they are present in the HAV during the real-world driving scenario. Implementations of the described techniques may include hardware, a method or process, or computer software on a computer-accessible medium.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a block diagram illustrating an operating environment for a reconstruction module according to some embodiments.

FIG. 1B is a block diagram illustrating a roadway environment including a set of vehicles including a reconstruction client which generates a sensor data log according to some embodiments.

FIG. 1C is a block diagram illustrating a flow process for generating execution data and review data based on a sensor data log according to some embodiments.

FIG. 2 is a block diagram illustrating an example computer system including a reconstruction module according to some embodiments.

FIGS. 3A and 3B are a flowchart of an example method for generating data that quantitatively describes areas for improving the performance of a set of ADAS systems according to some embodiments.

FIG. 4 is flowchart of an example method for generating simulation data according to some embodiments.

FIG. 5 is an example of a graphical user interface depicting a simulated version of a recorded collision which occurred in the real-world and is described by a sensor data log and two simulations based on the sensor data log but testing different simulated ADAS sensor sets according to some embodiments.

FIG. 6 is an example of a graphical user interface depicting execution data according to some embodiments.

FIG. 7 is an example of a graphical user interface depicting review data according to some embodiments.

### DETAILED DESCRIPTION

### ADAS Systems

Examples of an ADAS system may include one or more of the following elements of a vehicle: an adaptive cruise control (“ACC”) system; an adaptive high beam system; an adaptive light control system; an automatic parking system; an automotive night vision system; a blind spot monitor; a collision avoidance system; a crosswind stabilization system; a driver drowsiness detection system; a driver monitoring system; an emergency driver assistance system; a forward collision warning system; an intersection assistance system; an intelligent speed adaption system; a lane departure warning system; a pedestrian protection system; a traffic sign recognition system; a turning assistant; and a wrong-way driving warning system.

The ADAS system may also include any software or hardware included in the vehicle that makes that vehicle be an autonomous vehicle or a semi-autonomous vehicle.

In some embodiments, the ADAS system includes a processor such as described below with reference to the processors 125A, 125B. In some embodiments, the processor of the ADAS system include a graphics processing unit.

### Simulation Application

This application includes a simulation application. A simulation application includes a game engine, a virtualization application and modeling software.

A game engine includes any game engine capable of generating the virtual world described by the simulation data. For example, the game engine may include the Unity game engine published by Unity Technologies of San Francisco, Calif.

Virtualization applications, such as CarSim and Prescan, are increasingly used to test the correctness of an ADAS system included in a virtual vehicle modeled based on a real-world vehicle. Examples of virtualization applications include CarSim and Prescan. CarSim is produced and distributed by Mechanical Simulation Corporation of Ann Arbor, Mich. Prescan is produced and distributed by Tass International of Helmond, Netherlands. As described below, Prescan also includes a modeling application.

The modeling application includes software operable to generate one or more models (e.g., the vehicle model data and the ADAS model data) described above based on inputs provided by the user or data received other external sources (e.g., a model is updated via the network 105 or a tangible memory such as a Universal Serial Bus (“USB”) drive). The simulation application may include one or more modeling applications.

Different modeling applications may be specialized for generating particular types of models. For example, the hardware model and some of the software models for a vehicle design may be generated by a different modeling application than the software model for a set of ADAS systems included in the vehicle design (e.g., one modeling application generates the vehicle model data, whereas the different modeling applications generates the ADAS model data). For example, the simulation application may include one or more of the following example modeling applications: Dymola (produced by Dassault Systemes AB, Lund of Velizy-Villacoublay, France, and used to generate a vehicle model); MapleSim (produced by Maplesoft of Waterloo, Ontario, and used to generate a vehicle model); Simulink (produced by MathWorks of Natick, Mass., and used to generate models of an ADAS system); and PreScan (used to generate models of an ADAS system), etc.

Examples of the simulation application are described in the following patent applications, the entirety of which are hereby incorporated herein by reference: U.S. patent application Ser. No. 15/368,891, which is entitled “Geometric Proximity-Based Logging for Vehicle Simulation Application” and filed on Dec. 5, 2016; and U.S. patent application Ser. No. 15/265,235, which is entitled “Scalable Curve Visualization for Conformance Testing in Vehicle Simulation” and filed on Sep. 14, 2016.

### DSRC-Equipped Vehicle

In some embodiments, the vehicle is a DSRC-equipped vehicle. A DSRC-equipped vehicle is a vehicle that includes the following elements: a DSRC transceiver and any software or hardware necessary to encode and transmit a DSRC message; a DSRC receiver and any software or hardware necessary to receive and decode a DSRC message; and a DSRC-compliant GPS unit. The vehicle may include a first communication unit 145A that includes the DSRC transceiver and the DSRC receiver, as well as any software necessary for these hardware elements to provide their functionality.

### Lane-Level Accuracy

A DSRC-compliant GPS unit can provide GPS data (or GPS tags) describing the location of a vehicle (and instances of sensor measurements as described by the sensor data) with lane-level accuracy. Lane level accuracy may mean that the location of a vehicle is described so accurately that the vehicle's lane of travel may be accurately determined when traveling under an open sky (e.g., plus or minus 1.5 meters of the actual location of the vehicle). A conventional GPS system is unable to determine the location of a vehicle with lane-level accuracy. For example, a typical lane of a roadway is approximately 3 meters wide. However, a conventional GPS system may only have an accuracy of plus or minus 10 meters relative to the actual location of the vehicle.

A DSRC-compliant GPS unit may include hardware that wirelessly communicates with a GPS satellite to retrieve GPS data that describes a location of a vehicle with a precision that is compliant with the DSRC standard. The DSRC standard requires that GPS data be precise enough to infer if two vehicles are in the same lane. A DSRC-compliant GPS unit may be operable to identify, monitor and track its two-dimensional position within 1.5 meters of its actual position 68% of the time under an open sky. Since lanes of a roadway are typically no less than 3 meters wide, whenever the two-dimensional error of the GPS data is less than 1.5 meters the reconstruction module described herein may analyze the GPS data provided by the DSRC-compliant GPS unit and determine what lane of the roadway the vehicle is traveling in based on the relative positions of vehicles on the roadway. In this way, the DSRC-compliant GPS unit may beneficially provide GPS data with lane-level accuracy, thereby enabling the reconstruction module to more accurately identify the region ID for the vehicle and determine whether the local sensor data or the remote sensor data is more accurate based on the geographic location of the vehicle at a known time.

In some embodiments, devices other than vehicles may be DSRC-equipped. These DSRC-equipped devices may be used to relay remote sensor data to the vehicle via a DSRC message. For example, a roadside unit (“RSU”) or any other communication device may be DSRC-equipped if it includes one or more of the following elements: a DSRC transceiver and any software or hardware necessary to encode and transmit a DSRC message; and a DSRC receiver and any software or hardware necessary to receive and decode a DSRC message. The RSU may include a server 103 as described below and a second communication unit 145B of the server 103 may include the DSRC transceiver and the DSRC receiver, as well as any software necessary for these hardware elements to provide their functionality.

The embodiments described herein may use wirelessly transmit sensor data logs via a wireless message such as a DSRC message or a Basic Safety Message (“BSM”). These messages may be received by the server that includes the second communication unit 145B.

### Example Overview

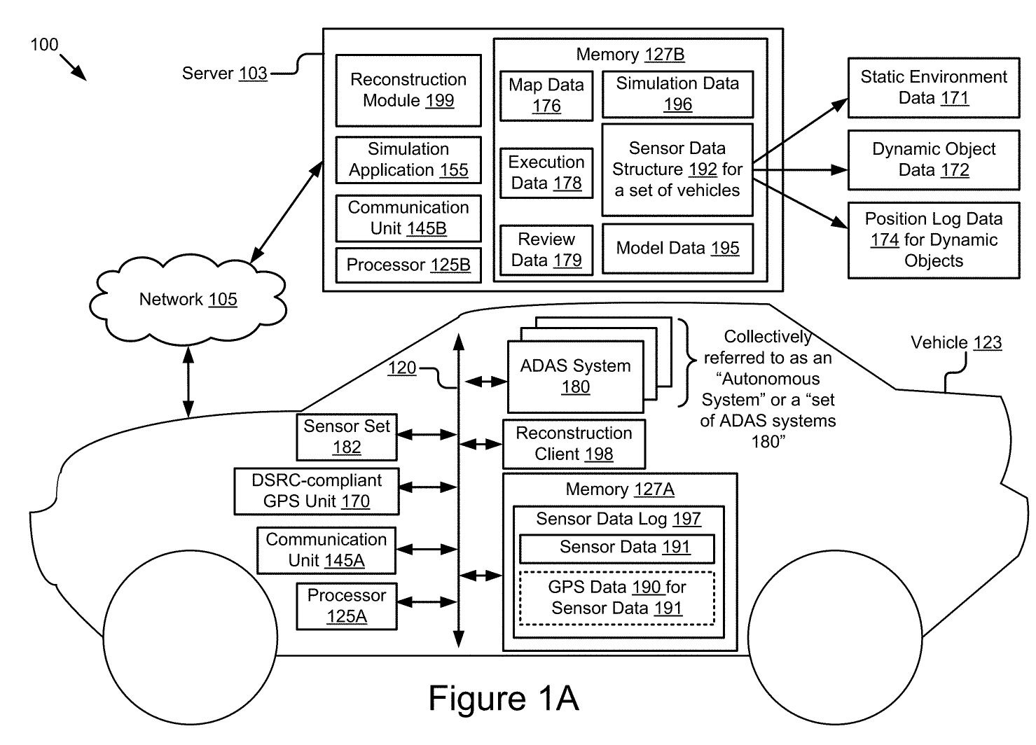

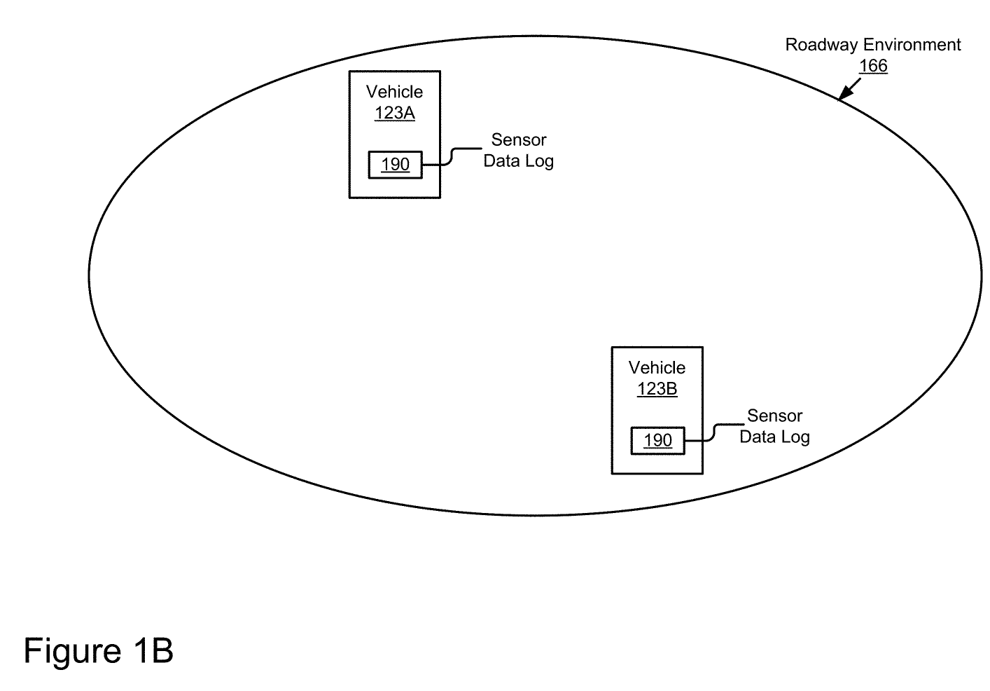

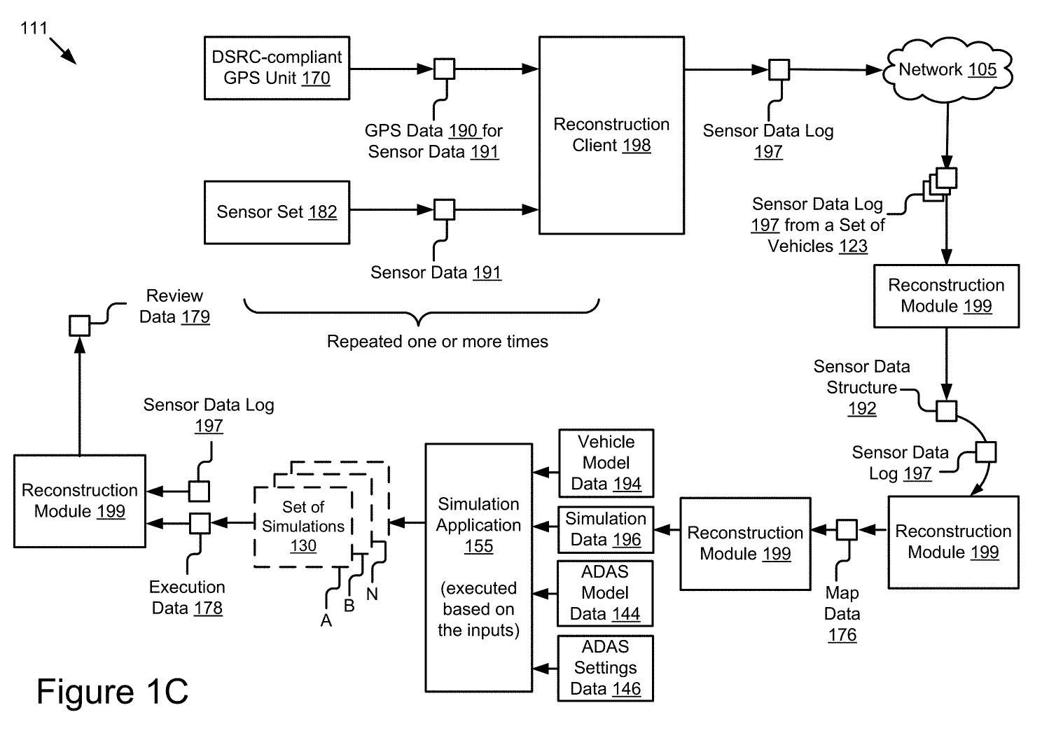

Referring to FIG. 1A, depicted is an operating environment 100 for a reconstruction module 199. The operating environment 100 may include one or more of the following elements: a vehicle 123; and a server 103. These elements of the operating environment 100 may be communicatively coupled to a network 105.

The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network 105 may include a peer-to-peer network. The network 105 may also be coupled to or may include portions of a telecommunications network for sending data in a variety of different communication protocols. In some embodiments, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, etc. The network 105 may also include a mobile data network that may include 3G, 4G, LTE, VoLTE or any other cellular network, mobile data network or combination of mobile data networks. Further, the network 105 may include one or more IEEE 802.11 wireless networks. Full-duplex communication includes the full-duplex wireless communication messages described in U.S. Pat. No. 9,369,262 filed on Aug. 28, 2014 and entitled “Full-Duplex Coordination System,” the entirety of which is hereby incorporated by reference.

In some embodiments, the vehicle 123 may be DSCR-equipped. The network 105 may include one or more communication channels shared among the vehicle 123 and one or more other wireless communication devices (e.g., the server 103 or other vehicles 123 present in the operating environment 100). The communication channel may include DSRC, full-duplex wireless communication, millimeter wave communication or any other wireless communication protocol. For example, the network 105 may be used to transmit a DSRC message, DSRC probe or BSM to the server 103 (which may be, for example, and element of a roadside unit).

The vehicle 123 may include a car, a truck, a sports utility vehicle, a bus, a semi-truck, a drone or any other roadway-based conveyance. In some embodiments, the vehicle 123 may include an autonomous vehicle or a semi-autonomous vehicle. For example, the vehicle 123 may include a set of ADAS systems 180.

The vehicle 123 may include one or more of the following elements: a sensor set 182; a first processor 125A; a first memory 127A; a first communication unit 145A; a DSRC-compliant GPS unit 170; a set of ADAS systems 180 which collectively form an autonomous system; and a reconstruction client 198. These elements of the vehicle 123 may be communicatively coupled to one another via a bus 120.

The vehicle 123 and the server 103 include some similar elements. For example, the server 103 includes the following elements that are similar to those included in the vehicle 123: a second processor 125B, which includes similar functionality as the first processor 125A, and so the second processor 125B and the first processor 125A are referred to herein collectively or individually as “the processor 125” or “a processor 125”; a second memory 127B, which includes similar functionality as the first memory 127A, and so the second memory 127B and the first memory 127A are referred to herein collectively or individually as “the memory 127” or “a memory 127”; and a second communication unit 145B which includes similar functionality as the first communication unit 145A, and so the second communication unit 145B and the first communication unit 145A are referred to herein collectively or individually as “the communication unit 145” or “a communication unit 145.”

In some embodiments, the processor 125 and the memory 127 of the vehicle 123 may be elements of an onboard vehicle computer system (not pictured). The onboard vehicle computer system may be operable to cause or control the operation of the reconstruction client 198. The onboard vehicle computer system may be operable to access and execute the data stored on the memory 127 to provide the functionality described herein for the reconstruction client 198 or its elements.

In some embodiments, the sensor set 182 includes one or more of the following vehicle sensors: a camera; a LIDAR sensor; a laser altimeter; a navigation sensor (e.g., a global positioning system sensor of the DSRC-compliant GPS unit 170); an infrared detector; a motion detector; a thermostat; a sound detector, a carbon monoxide sensor; a carbon dioxide sensor; an oxygen sensor; a mass air flow sensor; an engine coolant temperature sensor; a throttle position sensor; a crank shaft position sensor; an automobile engine sensor; a valve timer; an air-fuel ratio meter; a blind spot meter; a curb feeler; a defect detector; a Hall effect sensor, a manifold absolute pressure sensor; a parking sensor; a radar gun; a speedometer; a speed sensor; a tire-pressure monitoring sensor; a torque sensor; a transmission fluid temperature sensor; a turbine speed sensor (TSS); a variable reluctance sensor; a vehicle speed sensor (VSS); a water sensor; a wheel speed sensor; and any other type of automotive sensor.

The sensor set 182 may be operable to record data (referred to herein as “sensor data 191”) that describes one or more locations of the vehicle 123 at one or more different times; this data may be timestamped to indicate the time when the vehicle 123 was at this particular location.

The sensor set 182 may include one or more sensors that are operable to measure the physical environment outside of the vehicle 123. For example, the sensor set 182 may record one or more physical characteristics of the physical environment that is proximate to the vehicle 123. The measurements recorded by the sensor set are described by sensor data 191 which are stored in the memory 127 of the vehicle as an element of the sensor data log 197.

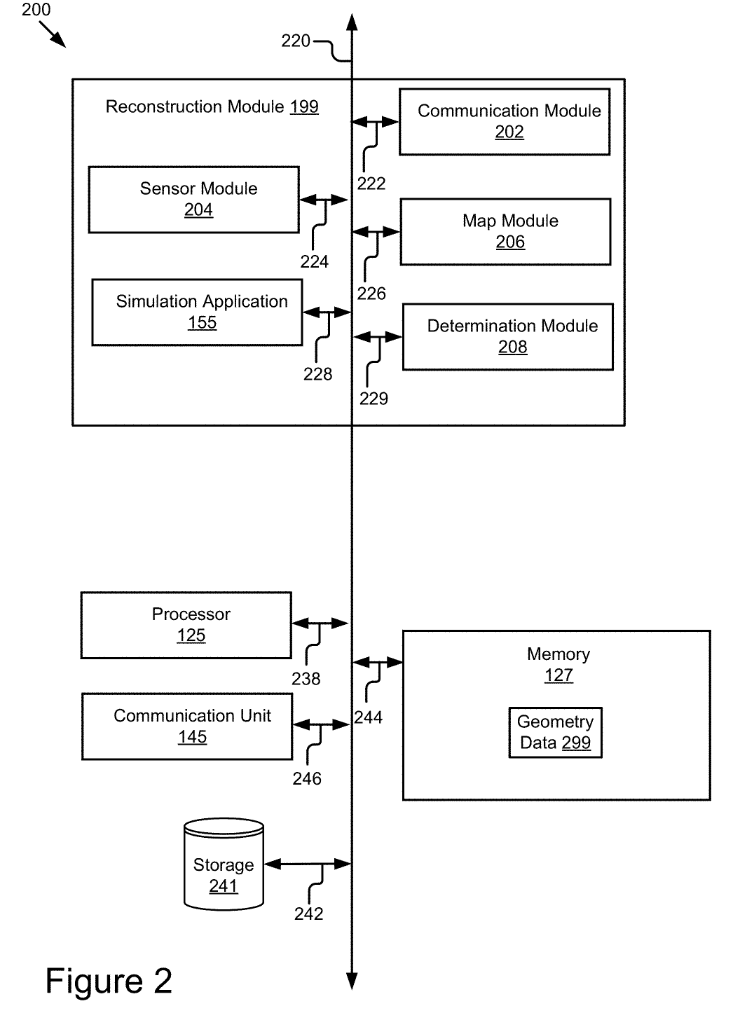

In some embodiments, the sensor data 191 may describe the physical environment proximate to the vehicle at one or more times. The sensor data 191 may be timestamped by the sensors of the sensor set 182 or the reconstruction client 198. The sensor data 191 may include one or more of the following data types, which themselves are eventually included in the sensor data structure 192 of the server 103 after the sensor data log 197 is transmitted to the server 103 by the reconstruction client 198 via the network 105: static environment data 171 which describes one or more static objects which are present in a roadway environment that includes the vehicle 123 (see, e.g., FIG. 2) at a given time (e.g., “t”); dynamic object data 172 which describes one or more dynamic objects which are present in the roadway environment that includes the vehicle 123 at the given time; and position log data 174 which describes the location or position of different dynamic objects (as described by, and optionally uniquely identified by, the dynamic object data 172) over a series of times (e.g., “t,” “t+1,” “t+2,” “t+N,” etc., where “N” represents any positive whole number).

In some embodiments, the sensor set 182 includes various sensors such as cameras, LIDAR, range finders, radar, etc. that are operational to measure, among other things: (1) the physical environment, or roadway environment, where the vehicle 123 is located as well as the static objects within this physical environment; (2) the dynamic objects within the physical environment and the behavior of these dynamic objects; (3) the position of the vehicle 123 relative to static and dynamic objects within the physical environment (e.g., as recorded by one or more range-finding sensors of the sensor set 182 such as LIDAR); (4) the weather within the physical environment over time and other natural phenomenon within the physical environment over time; (5) coefficients of friction and other variables describing objects (static and dynamic) within the physical environment over time; and (6) the operation of the set of ADAS systems 180 in response to the static and dynamic objects over time. One or more of these measurements are described by the sensor data 191 which is included in the sensor data log 197. The sensor data 191 may include a timestamp for each measurement.

In some embodiments, the GPS data 190 describes the geographic location of the vehicle 123 at a specific time as determined by the DSRC-compliant GPS unit 170 (such that the geographic location has lane-level accuracy). Because they GPS data 190 and the sensor data 191 each include a time element, the reconstruction client 198 is operable to combine the sensor data 191 and the GPS data 190 to form a sensor data log 197 that describes the measurements recorded by the sensor set 182 for the roadway environment that includes the vehicle 123 over time.

In some embodiments, the sensor data log 197 (which is formed by the sensor data 191 and the GPS data 190) describes (1) the real-world driving scenarios encountered by the vehicle 123 at different times and different geographic locations and (2) how the set of ADAS systems 180 of the vehicle 123 responded to these scenarios. In some embodiments, the GPS data 190 describes the geographic location of the vehicle 123 when it experienced different scenarios which are themselves described by the sensor data 191. In this way the GPS data 190 may be GPS tags that are associated with different instances of sensor data 191 (instances where a sensor of the sensor set 182 recorded some measurement). The GPS tags may be used by the reconstruction module 199 of the server to generate simulation data 196 that causes the simulation application 155 to generate a more accurate simulation of the roadway environment which existed during different real-world driving scenarios described by the sensor data 191. In this way, the sensor data 191 may be geo-stamped as well as timestamped.

As mentioned above, the sensor data 191 includes the static environment data 171, the dynamic object data 172 and the position log data 174.

The static objects described by the static environment data 171 include one or more objects of the roadway environment that are either static or substantially static in terms of their motion. For example, the static objects may include one or more of the following example static objects: a plant; a tree; a fire hydrant; a traffic sign; a roadside structure; a sidewalk; roadside equipment; and other static objects which may be present in a real-world roadway environment. These real-world static objects, which are described by the static environment data 171 of the sensor data 191, are virtualized for inclusion in the set of simulations that are described below with reference to the simulation application 155 and the simulation data 196. In this way the set of simulations may accurately measure and test the performance of different ADAS systems (e.g., the ADAS model data 144 shown in FIG. 1C) and ADAS system settings (e.g., the ADAS settings data 146) in a set of simulations which, although occurring in a virtual world, realistically represents the driving scenario encountered by the vehicle 123 in the real-world.

The dynamic objects described by the dynamic object data 172 (and referred to by the position log data 174) include one or more objects of the roadway environment that are either dynamic or dynamic static in terms of their motion. For example, the static objects may include one or more of the following example dynamic objects: other vehicles present in the roadway environment; pedestrians; animals; traffic lights; and environmental factors (wind, water, ice, variation of sun light, mud, other liquids); and other dynamic objects which may be present in a real-world roadway environment. These real-world dynamic objects, which are described by the dynamic object data 172 of the sensor data 191, are virtualized for inclusion in the set of simulations that are described below with reference to the simulation application 155 and the simulation data 196. In this way the set of simulations may accurately measure and test the performance of different ADAS systems and ADAS system settings in a set of simulations which, although occurring in a virtual world, realistically represents the driving scenario encountered by the vehicle 123 in the real-world.

The position log data 174 describes the distance from the vehicle 123 in the real-world and the dynamic objects in the real-world, which is a relevant measurement for determining the performance of one or more ADAS systems of the set of ADAS systems 180 included in the vehicle 123 since these systems should, among other things, avoid collisions while not scaring the driver of the vehicle 123.

The processor 125 includes an arithmetic logic unit, a microprocessor, a general purpose controller, or some other processor array to perform computations and provide electronic display signals to a display device. The processor 125 processes data signals and may include various computing architectures including a complex instruction set computer (“CISC”) architecture, a reduced instruction set computer (“RISC”) architecture, or an architecture implementing a combination of instruction sets. Although FIG. 1A includes a single processor 125, multiple processors may be included in the vehicle 123 (and the server 103). Other processors, operating systems, sensors, displays, and physical configurations may be possible.

The memory 127 of the vehicle 123 stores instructions or data that may be executed by the processor 125. The instructions or data may include code for performing the techniques described herein. The memory 127 may be a dynamic random access memory (DRAM) device, a static random access memory (SRAM) device, flash memory, or some other memory device. In some embodiments, the memory 127 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

As illustrated in FIG. 1A, in some embodiments the memory 127 stores one or more of the following elements: the sensor data 191; the GPS data 190; and the sensor data log 197. The sensor data 191 and the sensor data log 197 are described above.

The GPS data 190 may describe the location of the vehicle 123 at a given time. The GPS data 190 may be generated by the DSRC-compliant GPS unit 170. The GPS data 190 may describe a latitude and a longitude of the vehicle 123. The accuracy of the GPS data 190 may be compliant with the DSRC standard. As described above, different instances of GPS data 190 (or GPS tags) may be associated with different instances of sensor data 191 (an “instance” of sensor data 191 includes, for example, a discrete recording measured by one or more sensors of the sensor set 182; a discrete recording includes, for example, a picture, a LIDAR measurement for a given time, an acceleration measurement for a given time, a status of the brakes of the vehicle 123 for a given time, or any other discrete measurement for a given time) such that the geographic location of the vehicle 123 is known for each instance of the sensor data 191.

The data stored by the memory 127 of the server is described in more detail below with reference to the server 103 and the reconstruction module 199.

The communication unit 145 transmits and receives data to and from a network 105 or to another communication channel. In some embodiments, the communication unit 145 may include a DSRC transceiver, a DSRC receiver and other hardware or software necessary to make the vehicle 123 a DSRC-enabled device.

In some embodiments, the communication unit 145 includes a port for direct physical connection to the network 105 or to another communication channel. For example, the communication unit 145 includes a USB, SD, CAT-5, or similar port for wired communication with the network 105. In some embodiments, the communication unit 145 includes a wireless transceiver for exchanging data with the network 105 or other communication channels using one or more wireless communication methods, including: IEEE 802.11; IEEE 802.16, BLUETOOTH®; EN ISO 14906:2004 Electronic Fee Collection—Application interface EN 11253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); the communication method described in U.S. Pat. No. 9,369,262 filed on Aug. 28, 2014 and entitled “Full-Duplex Coordination System”; or another suitable wireless communication method.

In some embodiments, the communication unit 145 includes a full-duplex coordination system as described in U U.S. Pat. No. 9,369,262 filed on Aug. 28, 2014 and entitled “Full-Duplex Coordination System.”

In some embodiments, the communication unit 145 includes a cellular communications transceiver for sending and receiving data over a cellular communications network including via short messaging service (“SMS”), multimedia messaging service (“MMS”), hypertext transfer protocol (“HTTP” or “HTTPS” if the secured implementation of HTTP is used), direct data connection, WAP, e-mail, or another suitable type of electronic communication. In some embodiments, the communication unit 145 includes a wired port and a wireless transceiver. The communication unit 145 also provides other conventional connections to the network 105 for distribution of files or media objects using standard network protocols including TCP/IP, HTTP, HTTPS, and SMTP, millimeter wave, DSRC, etc.

The DSRC-compliant GPS unit 170 may include hardware that wirelessly communicates with a GPS satellite to retrieve GPS data 190 that describes a location of the vehicle 123 at a given time. In some embodiments, a DSRC-compliant GPS unit 170 is operable to provide GPS data 190 that describes the location of the vehicle 123 to a lane-level degree of precision. The DSRC standard requires that GPS data 190 be precise enough to infer if two vehicles (such as vehicle 123 and another vehicle on the same roadway as the vehicle 123) are in the same lane. The DSRC-compliant GPS unit 170 may be operable to identify, monitor and track its two-dimensional position within 1.5 meters of its actual position 68% of the time under an open sky. Since lanes of a roadway are typically no less than 3 meters wide, whenever the two-dimensional error of the GPS data 190 is less than 1.5 meters the reconstruction module 199 may analyze the GPS data 190 provided by the DSRC-compliant GPS unit 170 and determine what lane of the roadway the vehicle 123 is traveling in based on the relative positions of vehicles on the roadway.

By comparison, a GPS unit which is not compliant with the DSRC standard is far less accurate than the DSRC-compliant GPS unit 170 and not capable of reliably providing lane-level accuracy, as is the DSRC-compliant GPS unit 170. For example, a non-DSRC-compliant GPS unit may have an accuracy on the order of 10 meters, which is not sufficiently precise to provide the lane-level degree of precision provided by the DSRC-compliant GPS unit 170. For example, since a lane may be as narrow as 3 meters wide, the DSRC standard may require a DSRC-compliant GPS unit 170 to have an accuracy on the order of 1.5 meters, which is significantly more precise than a non-DSRC-compliant GPS unit as described above. As a result, a non-DSRC-compliant GPS unit may not be able to provide GPS data 190 that is accurate enough to enable the sensor data log 197 to precisely identify which lane the vehicle 123 was traveling in for a given driving scenario which is simulated by the simulation application 155 based on the simulation data 196 which is generated based on the sensor data log 197 itself. The imprecision of a non-DSRC-compliant GPS unit may therefore render the functionality of the reconstruction module 199 inoperable since the simulations generated based on the simulation data 196 would be unable to realistically or accurately recreate the scenario encountered by the real-world vehicle 123. The functionality and precision provided by the DSRC-compliant GPS unit 170 is therefore beneficial for this example reason.

The vehicle 123 includes a set of ADAS systems 180, which collectively form an autonomous system. Each ADAS system 180 provides one or more autonomous features to the vehicle 123.

In some embodiments, the set of ADAS systems 180 included in the vehicle 123 render the vehicle 123 a Highly Automated Vehicle (“HAV”). An HAV is a vehicle whose set of ADAS systems 180 operate at Level 3 or higher as defined by the NHTSA on page 9 of their policy paper entitled “Federal Automated Vehicles Policy: Accelerating the Next Revolution in Roadway Safety,” which was published in September of 2016. Accordingly, in some embodiments the vehicle 123 is a HAV. In this way the vehicle 123 may be an HAV and also DSRC-enabled as described above. The reconstruction module 199 and the reconstruction client 198 described herein beneficially provide a way to quantitatively describe the performance of a set of ADAS systems 180 that collectively operate at Level 3 or higher and to identify areas for improving the performance of such sets of ADAS systems 180. No other technology exists that provides this functionality.

An ADAS system from the set of ADAS systems 180 is referred to herein individually as “an ADAS system 180.” The one or more ADAS systems 180 of the vehicle 123 are referred to herein collectively as “a set of ADAS systems 180,” “the set of ADAS systems 180,” “an autonomous system” or “the autonomous system.”

An ADAS system 180 may include one or more advanced driver assistance systems. Examples of an ADAS system 180 may include one or more of the following elements of a vehicle 123: an ACC system; an adaptive high beam system; an adaptive light control system; an automatic parking system; an automotive night vision system; a blind spot monitor; a collision avoidance system; a crosswind stabilization system; a driver drowsiness detection system; a driver monitoring system; an emergency driver assistance system; a forward collision warning system; an intersection assistance system; an intelligent speed adaption system; a lane departure warning system; a pedestrian protection system; a traffic sign recognition system; a turning assistant; and a wrong-way driving warning system.

In some embodiments, the set of ADAS systems 180 includes any hardware or software that controls one or more operations of the vehicle 123 so that the vehicle 123 is “autonomous” or “semi-autonomous.”

In some embodiments, the set of ADAS systems 180 includes any hardware or software that controls one or more operations of the vehicle 123 so that the vehicle 123 is an HAV.

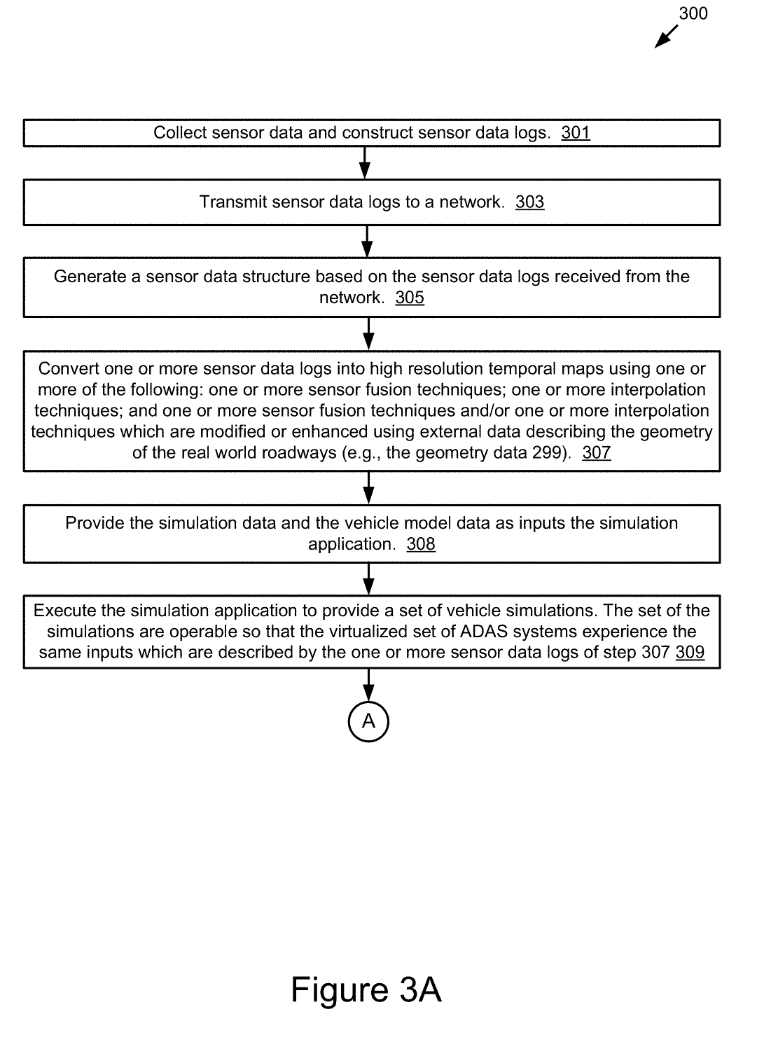

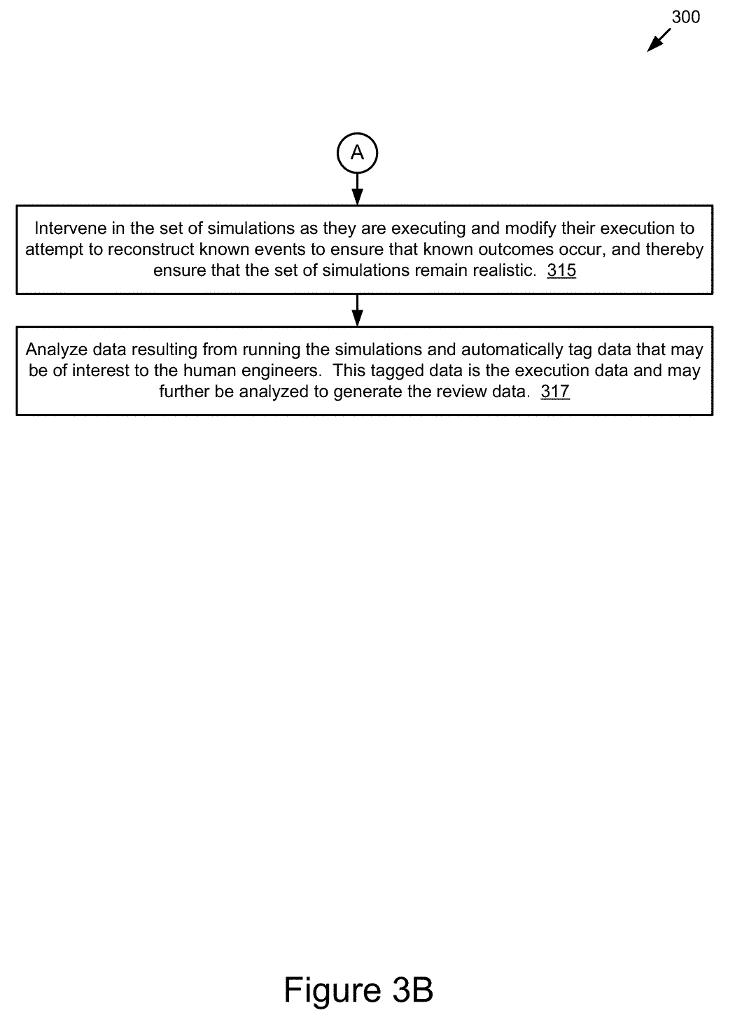

In some embodiments, the reconstruction client 198 includes code or routines that are operable, when executed by the processor 125 of the vehicle 123, to cause the processor 125 to perform one or more of the following steps: execute the sensor set 182 and the DSRC-compliant GPS unit 170 at different times to generate the sensor data 191 and the GPS data 190; build the sensor data log 197 based on the sensor data 191 and the GPS data 190; and cause the communication unit 145 of the vehicle 123 to transmit the sensor data log 197 to the server 103 via the network 105. The functionality of the reconstruction client 198 is described in more detail below with reference to the flow process 111 of FIG. 1C or the method 300 of FIGS. 3A and 3B.

In some embodiments, the reconstruction client 198 may be implemented using hardware including a field-programmable gate array (“FPGA”) or an application-specific integrated circuit (“ASIC”). In some other embodiments, the reconstruction client 198 may be implemented using a combination of hardware and software. The reconstruction client 198 may be stored in a combination of the devices of the operating environment 100 (e.g., vehicles, servers or other devices such as a smartphone of the driver of the vehicle 123), or in one of the devices (e.g., the vehicle 123).

Although not depicted in FIG. 1A, in some embodiments the vehicle 123 may include a full-duplex coordination system as described in U.S. Pat. No. 9,369,262 and entitled “Full-Duplex Coordination System.”

The server 103 is a processor-based computing device. For example, the computing device may include a standalone hardware server. The server 103 is communicatively coupled to the network 105.

The server 103 is operable to receive one or more sensor data logs 197 from one or more vehicles 123 which are communicatively coupled to the network 105. For example, the communication unit 145 of the server 103 receives one or more wireless messages from the network 105, and these wireless messages each include a sensor data log 197 for a set of vehicles 123.

The server 103 includes one or more of the following elements: the processor 125; the communication unit 145; the memory 127; a simulation application 155 ; and a reconstruction module 199. Although not depicted in FIG. 1A, in some embodiments the server 103 includes an electronic display device (e.g., a monitor) for visually display one or more simulations provided by the processor 125 executing the simulation application 155 using the model data 195 and the simulation data 196 as an input for the simulation application 155.

The following elements of the server 103 were described above with reference to the vehicle 123, and so, there descriptions will not be repeated here: the processor 125; the communication unit 145; and the memory 127.

The simulation application 155 includes a Modelica-based vehicle simulation software such as CarSim or some other Modelica-based vehicle simulation software that is operable to receive the model data 195 and the simulation data 196 as an input provided by the reconstruction module 199 and output, once executed by the processor 125 of the server 103, a set of simulations for testing the operation of one or more virtual versions of the vehicle 123 with different variations for a virtual set of ADAS systems 180 included in the one or more virtual versions of the vehicle 123. In some embodiments, the simulation application 155 also includes one or more different types of modeling software and a gaming engine as described above.

In some embodiments, the modeling software of the simulation application 155 generates one or more models which are described by the model data 195. The model data 195 is described in more detail below.

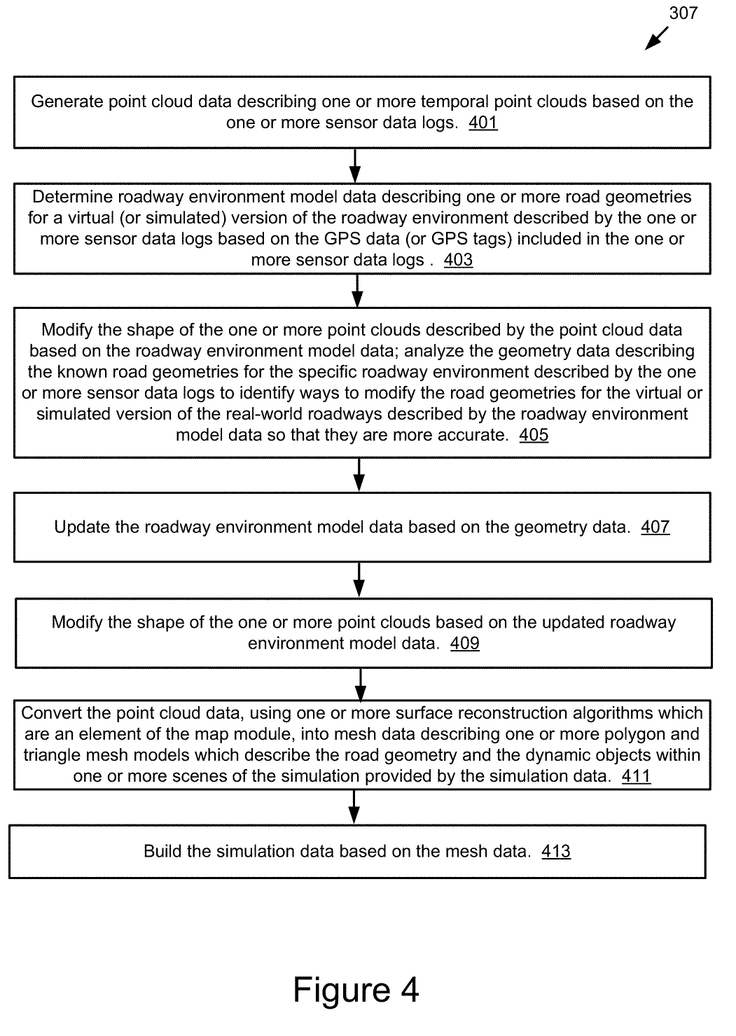

The reconstruction module 199 includes code and routines that are operable, when executed by the processor of the server 103, to execute one or more of the steps described below with reference to the flow process 111 of FIG. 1C, the method 300 of FIG. 3A and 3B and the step 307 of FIG. 4.

In some embodiments, the reconstruction module 199 includes software that analyzes the sensor data logs 197 stored in the sensor data structure 192 to generate the simulation data 196. The reconstruction module 199 may include a modified version of the Simultaneous Localization and Mapping (“SLAM”) algorithm for generating point clouds. The reconstruction module 199 may also include a surface reconstruction algorithm for generating surfaces and a learning algorithm for learning the identity of objects represented in the sensor data logs 197 over time.

In some embodiments, the reconstruction module 199 of the server 103 includes code and routines that are operable, when executed by the processor 125 of the server 103, to cause the processor 125 to: (1) build the sensor data structure 192 based on one or more sensor data logs 197 received from a set of vehicles; and (2) store the sensor data structure 192 in the memory 127 of the server 103. The set of vehicles includes one or more vehicles 123 which have transmitted a sensor data log 197 to the server 103.

The memory 127 of the server 103 stores the following elements: the sensor data structure 192; the model data 195; the simulation data 196; the execution data 178; the review data 179; and the map data 176.

The sensor data structure 192 includes any data structure that is operable to store the sensor data logs 197 received by the server 103 in a way that is accessible and understandable by the reconstruction module 199. The reconstruction module 199 includes code and routines that are operable, when executed by the processor 125 of the server 103, to cause the processor 125 to generate the simulation data 196 based on one or more sensor data logs 197 stored in the sensor data structure 192. For example the sensor data structure 192 may include a database or table that organizes and stores the sensor data logs based on one or more of time and geographic location as described by the sensor data logs 197 which are organized in the sensor data structure 192.

In some embodiments, the reconstruction module 199, once executed by the processor 125, causes the processor 125 to perform steps including: (1) accessing the sensor data structure 192 store on the memory 127; (2) retrieving a sensor data log 197 for a particular vehicle 123 from the sensor data structure 192; (3) generating map data 176 based on the sensor data log 197; and (4) generating simulation data 196 based on the map data 176. Steps (3) and (4) are described in more detail below with reference to FIG. 4. In this way the reconstruction module 199 generates the simulation data 196 for a particular vehicle 123 based on the sensor data log 197 provided by that vehicle 123.

The model data 195 describes any digital models that are necessary for the simulation application 155 to provide its functionality. In some embodiments, some of the digital models described below are elements of the map data 176 which is used to generate the simulation data 196 by the reconstruction module 199.

In some embodiments, the functionality of the simulation application 155 includes generating one or more simulations which accurately and realistically simulate the operation of a virtual version of the vehicle 123, i.e., a virtual vehicle 123. The virtual vehicle 123 includes one or more of the following: the set of ADAS systems 180 of the vehicle 123; and variations for the set of ADAS systems 180 of the vehicle including different designs for the ADAS systems 180 of the vehicle, different settings for the ADAS systems and different ADAS systems 180 or combinations of ADAS systems 180. The ADAS settings data 146 depicted in FIG. 1C describes the different settings for the ADAS systems which may be tested by the one or more simulations. The ADAS model data 144 describes the different ADAS systems 180, designs for different ADAS systems 180 or combinations of different ADAS systems 180 which may be tested by the one or more simulations. The virtual vehicle 123 is generated based on a vehicle model described by the model data 195, and in particular the vehicle model data 194 depicted in FIG. 1C.

In some embodiments, the operation of the virtual vehicle 123, it's virtualized set of ADAS systems 180 (e.g., described by one or more of the ADAS model data 144 and the ADAS settings data 146 of FIG. 1C) and the virtualized roadway environment upon which the virtual vehicle 123 operates within the one or more simulations (e.g., described by the simulation data 196 which is based on the map data 176) is based on the sensor data log 197 provided by the vehicle 123.

In some embodiments, the one or more simulations include a virtual world which accurately and realistically represents one or more driving scenarios experienced by the vehicle 123 that provided the sensor data log 197. The virtual world included in the simulation includes the static and dynamic objects for the one or more driving scenarios experienced by the vehicle 123 as described by the sensor data log 197 provided by the vehicle 123.

In some embodiments, the model data 195 describes one or more of the following: (1) a vehicle model for a particular vehicle 123 (e.g., a vehicle 123 having a particular make, model and trim level, or a particular Vehicle Identification Number, “VIN,” or some other unique identifier of the particular vehicle 123 whose operation and driving scenarios are described by a particular sensor data log 197) whose particular sensor data log 197 is being used to generate simulation data 196 for analysis by one or more human designers of the set of ADAS systems 180 for that particular vehicle 123; (2) a roadway environment model for the roadway environment described sensor data log 197 that is associated with the particular vehicle 123; (3) models for one or more dynamic objects and the behavior of these dynamic objects within the simulation, etc.); and (4) models for the set of ADAS systems 180 of the particular vehicle 123 or variations for the settings or design of the ADAS systems 180 such as different parameters for an existing ADAS system 180, different designs for an existing ADAS system 180, different combinations of ADAS systems 180 being included in the set of ADAS systems 180 and new designs for ADAS systems 180 to be included in the set of ADAS systems 180.

The simulation data 196 includes data which is operable, when executed by the simulation application 155 along with the model data 195, to cause the simulation application 155 to provide a set of simulations described above for testing the operation of a virtual vehicle 123 (and a virtualized set of ADAS systems 180 which are a component of the virtual vehicle 123) as provided by the simulation application 155 based on the model data 195.

In some embodiments, the simulation data 196 includes data which is operable, when executed by the simulation application 155 along with the model data 195, to cause the simulation application 155 to provide a set of simulations including a virtual environment for a virtual version of the vehicle 123. This virtual environment includes the static objects and dynamic objects described by one or more sensor data logs 197.

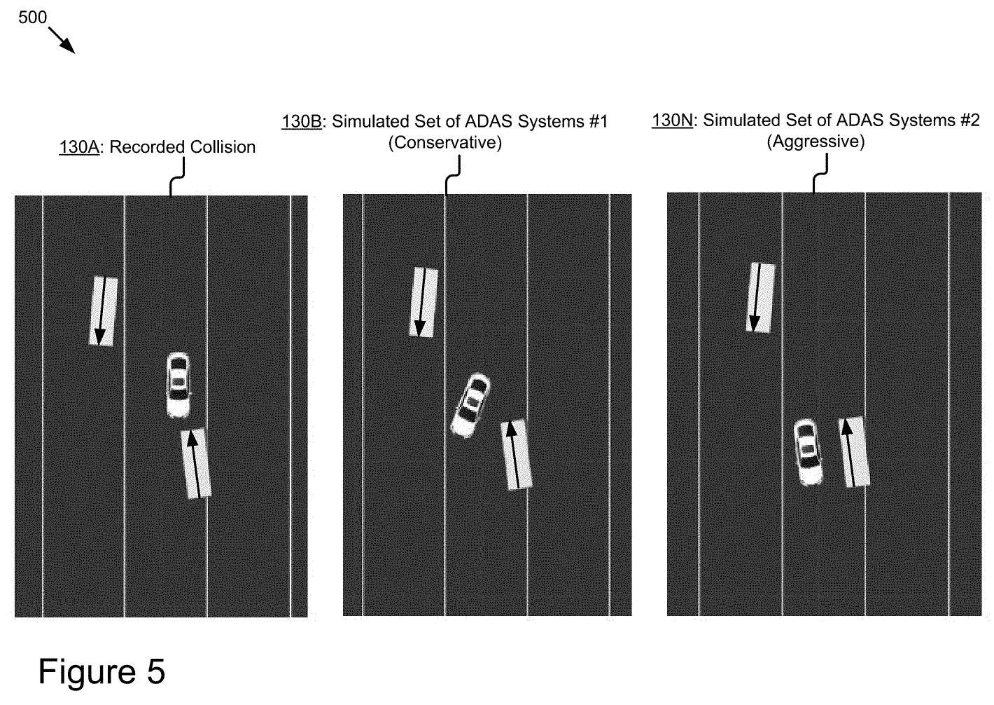

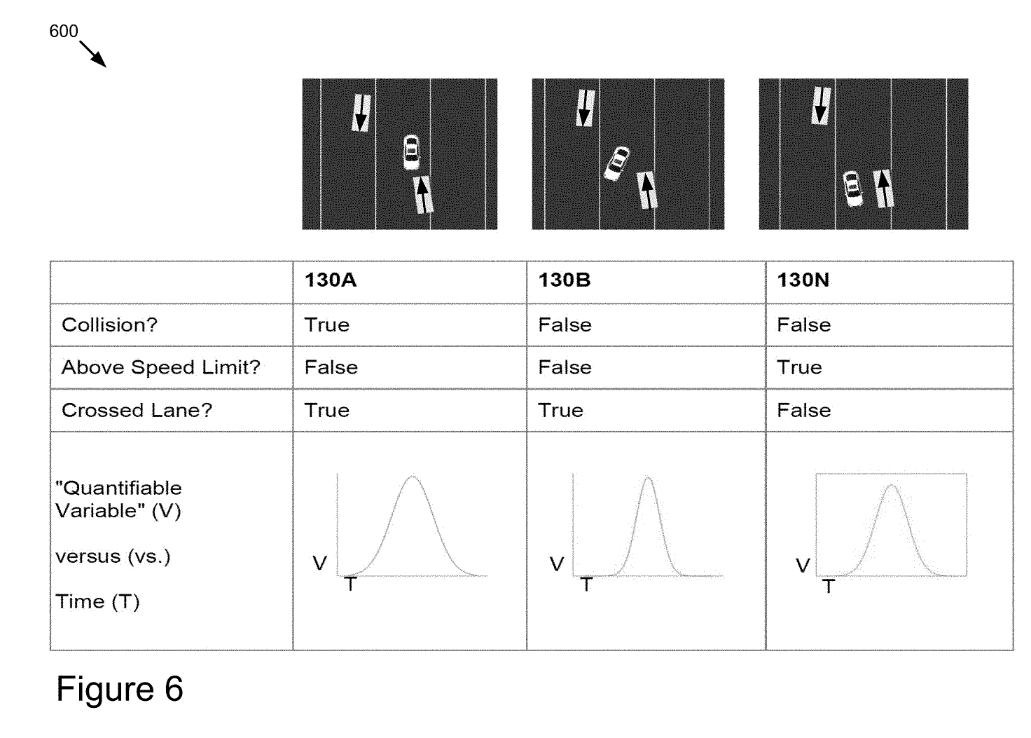

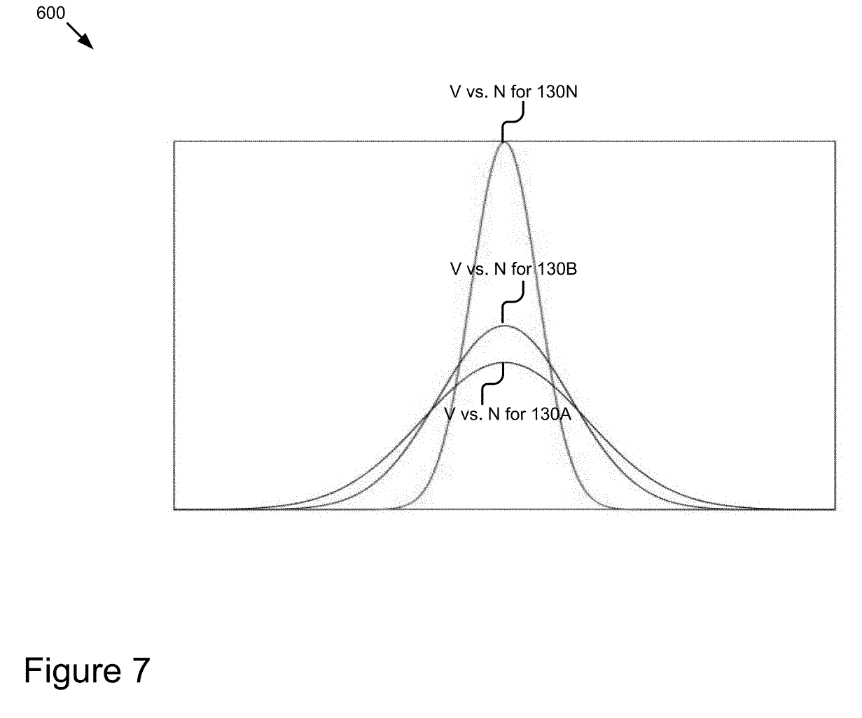

In some embodiments, the simulation data 196 includes a set of executable files which are executed by the processor 125 of the server to provide the one or more simulations. The different executable files included in the set of executable files individually test a different configuration for the virtualized set of ADAS systems 180 included in an a virtualized vehicle 123. In this way, the operation of the virtualized vehicle 123 may be testing using different configurations for the virtualized set of ADAS systems 180 included in the virtualized vehicle 123 so that the relative performance of these configurations can be quantified and judged. FIG. 5 depicts an example of different configurations for the virtualized set of ADAS systems 180 included in a virtualized vehicle. The simulation application 155 executes the different executable files to provide the one or more simulations. The reconstruction module 199 includes code and routines that are operable, when executed by the processor 125, to cause the processor 125 to monitor the execution of the one or more simulations and generate execution data 178 for the different configurations of the virtualized set of ADAS systems 180 described by the one or more executable files of the simulation data 196. The execution data 178 describes the operation of the different configurations of the virtualized set of ADAS systems 180 of the virtualized vehicle 123. FIG. 6 depicts an example of execution data 178 that includes quantifiable data that describes the performance of the different configurations for the virtualized set of ADAS systems 180 shown in FIG. 5. The reconstruction module 199 includes code and routines that are operable, when executed by the processor 125, to cause the processor 125 to analyze the execution data 178 and generate review data 179 that describes one or more areas for improving the operation or design of the set of ADAS systems 180 of the vehicle 123 based on the one or more simulations and the testing of the different configurations for the set of ADAS systems 180. FIG. 7 depicts an example of the review data 179.

In some embodiments, the simulation application 155 includes code and routines that are operable, when executed by the processor 125, to cause the process to provide a set of simulations for testing the operation of the one or more ADAS models described by the model data 195.

In some embodiments, the simulation application 155, upon being executed by the processor 125 of the server 103, provides a set of simulations based on these models described above. The set of simulations are configured to test a vehicle design for the vehicle to determine whether this design, and aspects of this design such as the set of ADAS systems 180 of the vehicle 123, operate in conformity with the expectations and specifications of a human user of the server 103 and one or more industry or governmental standards that are application to the operation of the set of ADAS systems 180.

In some embodiments, the reconstruction module 199 may be implemented using hardware including a FPGA or an ASIC. In some other embodiments, the reconstruction module 199 may be implemented using a combination of hardware and software. The reconstruction module 199 may be stored in a combination of the devices of the operating environment 100 (e.g., vehicles, servers or other devices), or in one of the devices (e.g., the server 103).

Referring now to FIG. 1B, depicted is a roadway environment 166 including a set of vehicles 123A, 123B. The set of vehicles 123A, 123B each include a reconstruction client. The reconstruction client of each vehicle generates a sensor data log, which is then transmitted to the server via the network. In this way the sensor data structure of the server includes different sensor data logs for different vehicles 123A, 123B.

Referring now to FIG. 1C, depicted is a flow process 11 for generating execution data 178 and review data 179 based on a sensor data log 197 according to some embodiments.

The reconstruction client 198 includes code and routines that are operable, when executed by a processor of the vehicle, to cause the processor to execute one or more of the following steps: (1) generating a sensor data log 197 based on sensor data 191 recorded at one or more times and GPS data 190 for the sensor data 191 which is retrieved for the one or more times corresponding to the sensor data 191; and (2) instructing the communication unit of the vehicle to transmit the sensor data log 197 to the network 105.

The reconstruction module 199 receives one or more sensor data logs 197 from one or more vehicles 123 via the network 105.

The reconstruction module 199 includes code and routines that are operable, when executed by a processor of the server, to cause the processor to execute one or more of the following steps: (1) building a sensor data structure 192 based on the one or more sensor data logs 197; (2) building map data 176 based on a sensor data log 197 retrieved from the sensor data structure 192; (3) generating the simulation data 196 for the sensor data log 197 based on the map data 176; and (4) providing the following data as inputs to the simulation application 155: (a) simulation data 196, (b) vehicle model data 194 for the vehicle which provided the sensor data log 197 which was used to generate the map data 176 that yielded the simulation data 196 and (c) ADAS model data 144 or ADAS settings data 146 to be evaluated by the set of simulations provided by the simulation application 155.

The reconstruction module 199 includes code and routines that are operable, when executed by a processor of the server, to cause the processor to execute the simulation application 155 based on the inputs described above. For example, the simulation data 196 includes a set of executable files which reference or are linked to the data described by the vehicle model data 194 and the ADAS model data 144 or the ADAS settings data 146.

The following elements of the flow process 111 are elements of the model data described above with reference to FIG. 1A: the vehicle model data 194; the ADAS model data 144; and the ADAS settings data 146.

The vehicle model data 194 describes a model for the vehicle which provided the sensor data log 197 used to generate the simulation data 196.

The ADAS model data 144 describes one or more of the following: one or more models for the set of ADAS systems 180 of the vehicle which provided the sensor data log 197 used to generate the simulation data 196; variations for the parameters for the set of ADAS systems 180 of the vehicle which provided the sensor data log 197 used to generate the simulation data 196; designs for one or more different ADAS systems which are candidates to be included in the set of ADAS systems 180 of the vehicle which provided the sensor data log 197 used to generate the simulation data 196; modifications for the designs for the one or more ADAS systems included in the set of ADAS systems 180 of the vehicle which provided the sensor data log 197 used to generate the simulation data 196; etc.

The ADAS settings data 146 describes variations for the settings of the ADAS systems 180 included in the set of ADAS systems 180 of the vehicle which provided the sensor data log 197 used to generate the simulation data 196. The settings for the ADAS systems 180 include data or variables which are operable to control the operation of the ADAS systems included in the set of ADAS systems 180 of the vehicle.

A processor of the server executes the simulation application 155 based on these inputs and the simulation application 155 outputs a set of simulations A, B . . N where “N” indicates that the set of simulations includes any positive whole number of simulations. In some embodiments, each simulation included in the set tests a different variation for the set of ADAS systems 180 of the vehicle whose vehicle design is being tested (see, e.g., FIGS. 5, 6 and 7).

The reconstruction module 199 includes code and routines that are operable, when executed by a processor of the server, to cause the processor to perform one or more of the following steps: (1) monitor the set of simulations 130 and generate execution data 178 which describes the operation of the different variations for the set of ADAS systems 180 of the vehicle; and (2) analyze the execution data 178 to generate the review data 179.

Referring now to FIG. 2, depicted is a block diagram illustrating an example computer system 200 including a reconstruction module 199 according to some embodiments.

In some embodiments, the computer system 200 may include a special-purpose computer system that is programmed to perform one or more steps of a method 300 described below with reference to FIGS. 3A and 3B, a method described below with reference to FIG. 4 or the flow process 111 described above with reference to FIG. 1C.

In some embodiments, the computer system 200 may be an element of the server 103.

The computer system 200 may include one or more of the following elements according to some examples: the reconstruction module 199; the processor 125; the communication unit 145; the memory 127; and a storage 241. The components of the computer system 200 are communicatively coupled by a bus 220.

In the illustrated embodiment, the processor 125 is communicatively coupled to the bus 220 via a signal line 238. The communication unit 145 is communicatively coupled to the bus 220 via a signal line 246. The storage 241 is communicatively coupled to the bus 220 via a signal line 242. The memory 127 is communicatively coupled to the bus 220 via a signal line 244.

The following elements of the computer system 200 were described above with reference to FIG. 1A, and so, those descriptions will not be repeated here: the processor 125; the communication unit 145; and the memory 127.

The memory 127 stores any data necessary for the reconstruction module 199 to provide its functionality. For example, the memory 127 stores any of the data described above with reference to FIGS. 1A, 1B and 1C.

In the embodiment depicted in FIG. 2 the memory 127 stores geometry data 299. The geometry data 299 includes digital data that describes the geometry of one or more real-world roadways which are included in the roadway environment 166. The geometry data 299 may not include electronic maps of a roadway environment as this data would be computationally expense to analyze due to the included graphics and other non-beneficial information, but instead includes data that describes just the geometry of one or more real-world roadways and the roadway infrastructure elements and their position (or geographic location) relative to one another and the roadway itself.

The storage 241 can be a non-transitory storage medium that stores data for providing the functionality described herein. The storage 241 may be a dynamic random access memory (“DRAM”) device, a static random access memory (“SRAM”) device, flash memory, or some other memory devices. In some embodiments, the storage 241 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In the illustrated embodiment shown in FIG. 2, the reconstruction module 199 includes a communication module 202, a sensor module 204, a map module 206, the simulation application 155 and a determination module 208. These components of the reconstruction module 199 are communicatively coupled to each other via a bus 220. In some embodiments, components of the reconstruction module 199 can be stored in a single server or device. In some other embodiments, components of the reconstruction module 199 can be distributed and stored across multiple servers or devices. For example, some of the components of the reconstruction module 199 may be distributed across the server 103 and the vehicle 123.

The communication module 202 can be software including routines for handling communications between the reconstruction module 199 and other components of the computer system 200. In some embodiments, the communication module 202 can be a set of instructions executable by the processor 125 to provide the functionality described below for handling communications between the reconstruction module 199 and other components of the computer system 200.

The communication module 202 sends and receives data, via the communication unit 145, to and from one or more elements of the operating environment 100 or the flow process 111. For example, the communication module 202 receives or transmits, via the communication unit 145, one or more of the following elements: the map data; the simulation data; the execution data; one or more sensor data logs 197; the review data 179; and the model data 195.

In some embodiments, the communication module 202 receives data from components of the reconstruction module 199 and stores the data in one or more of the storage 241 and the memory 127. For example, the communication module 202 receives any of the data described above with reference to the memory 127 and stores this data in the memory 127.

In some embodiments, the communication module 202 may handle communications between components of the reconstruction module 199. For example, the communications module 202 may handle communications among the sensor module 204, the map module 206, the simulation application 155 and the determination module 208. Any of these modules may cause the communication module 202 to communicate with the other elements of the computer system 200.

For example, the sensor module 204 may use the communication module 202 to communicate with the communication unit 145 and the memory 127 so that one or more sensor data logs are received from the communication unit 145 and used to build the sensor data structure which is stored in the memory 127 or stored within the sensor data structure of the memory 127. The map module 206 may use the communication module 202 to communicate with the memory 127 to retrieve one or more sensor data logs from the sensor data structure, which is then used by the map module 206 to execute step 307 of FIG. 3A and one or more of the steps described below with reference to FIG. 4. The simulation application 155 may use the communication module 202 to communicate with the memory 127 to retrieve one or more of the simulation data, vehicle model data, ADAS model data and the ADAS settings data stored in the memory 127, which are then executed using the simulation application 155 to provide a set of simulations. The determination module 208 may use the communication module 202 to monitor the set of simulations and generate the execution data and the review data 179 which are then stored on the memory 127 by the determination module 208 using the communication module 202.

In some embodiments, the communication module 202 can be stored in the memory 127 of the computer system 200 and can be accessible and executable by the processor 125. The communication module 202 may be adapted for cooperation and communication with the processor 125 and other components of the computer system 200 via signal line 222.

The sensor module 204 can be software including routines for building the sensor data structure based on one or more sensor data logs.

In some embodiments, the sensor module 204 may generate local sensor data 191 describing the measurements of the sensor set 182. The sensor module 204 may cause the local sensor data 191 to be stored in the memory 127.

In some embodiments, the sensor module 204 can be stored in the memory 127 of the computer system 200 and can be accessible and executable by the processor 125. The sensor module 204 may be adapted for cooperation and communication with the processor 125 and other components of the computer system 200 via the signal line 224.

The map module 206 can be software including routines that, when executed by the processor 125, cause the processor 125 to converts the sensor data logs into high resolution temporal maps which are operable to construct a simulated environment. For example, the map module 206, when executed by the processor 125, converts the sensor data logs into high resolution temporal maps using one or more of the following: one or more sensor fusion techniques; one or more interpolation techniques; and one or more sensor fusion techniques and/or one or more interpolation techniques which are modified or enhanced using external data describing the geometry of the real world roadways (e.g., the geometry data 299).

In some embodiments, the map module 206 can be software including routines that, when executed by the processor 125, cause the processor 125 to perform one or more of the steps described below with reference to FIG. 4.

In some embodiments, the map module 206 includes code and routines that, when executed by the processor 125, receive one or more sensor data logs as an input and then execute one or more of the following steps based on this input: (1) generate point cloud data describing one or more temporal point clouds based on the one or sensor more data logs; (2) determine roadway environment model data describing one or more road geometries for a virtual (or simulated) version of the roadway environment described by the one or more sensor data logs based on the GPS data (or GPS tags) included in the one or more sensor data logs (which is similar to generating a roadway model as described above); (3) modify the shape of the one or more point clouds described by the point cloud data based on the roadway environment model data; analyze the geometry data describing the known road geometries for the specific roadway environment described by the one or more sensor data logs to identify ways to modify the road geometries for the virtual or simulated version of the real-world roadways described by the roadway environment model data so that they are more accurate; (4) update the roadway environment model data based on the geometry data; (5) modify the shape of the one or more point clouds based on the updated roadway environment model data; (6) convert the point cloud data, using one or more surface reconstruction algorithms which are an element of the map module 206, into mesh data describing one or more polygon and triangle mesh models which describe the road geometry and the dynamic objects within one or more scenes of the simulation provided by the simulation data 196; and (7) build the simulation data based on the mesh data.

In some embodiments, because the scenes of the simulation provided by the simulation application 155 generating the simulation data is not generated in real time, the reconstruction module includes one or more learning algorithms which are operable to learn the identity of objects recognized by cameras of the real-world vehicle 123.

In some embodiments, the map module 206 can be stored in the memory 127 of the computer system 200 and can be accessible and executable by the processor 125. The map module 206 may be adapted for cooperation and communication with the processor 125 and other components of the computer system 200 via signal line 226.

The simulation application 155 was described above with reference to FIGS. 1A, 1B and 1C, and those descriptions will not be repeated here.

In some embodiments, the simulation application 155 can be stored in the memory 127 of the computer system 200 and can be accessible and executable by the processor 125. The simulation application 155 may be adapted for cooperation and communication with the processor 125 and other components of the computer system 200 via signal line 228.

The determination module 208 can be software including routines that, when executed by the processor 125, cause the processor 125 to implement one or more of the following steps: (1) provide one or more of the vehicle model data 194, the simulation data, the ADAS model data and the ADAS settings data to the simulation application 155 as inputs; (2) cause the processor 125 to execute the simulation application 155 using these inputs; (3) monitor the execution of the set of simulations to generate the execution data 178 for the set of simulations (see, e.g., FIG. 5); (4) retrieve the sensor data log 197; (5) analyze the sensor data log 197 and the execution data 178 to generate the review data 179; and (6) generate a graphical display the depicts one or more of the execution data 178 and the review data 179.

In some embodiments, as the simulation is executing, the determination module 208 includes code and routines that are operable to interrupt the operation of the simulation application 155 and provide a graphical user interface that enables the one or more human engineers to provide inputs via the graphical user interface which describe one or more new autonomous control systems which modify the ADAS model data 144 or the ADAS settings data 146 and then restart execution of the simulation application 155 based on these modified inputs so that the simulations provided from this point forward enable the engineers to monitor the set of simulations to assess how these systems will respond to the environment using these modifications. In this way the engineers may also tweak the environmental conditions present in the set of simulations to assess how this affects the operation of the virtualized set of ADAS systems.

In some embodiments, the determination module 208 includes code and routines that are operable, when executed by the processor 125, to cause the processor 125 to intervene in the set of simulations as they are executing and modifying their execution to attempt to reconstruct known events to ensure that known outcomes occur, and thereby ensure that the set of simulations remain realistic.

In some embodiments, the execution data may describe one or more metrics for assessing the operation of the virtualized set of ADAS systems. For example, the execution data may describe one or more of the following: stopping distances; stopped gaps; acceleration delay; distances maintained between vehicles; collisions; collision velocities, etc.

In some embodiments, the determination module 208 can be stored in the memory 127 of the computer system 200 and can be accessible and executable by the processor 125. The determination module 208 may be adapted for cooperation and communication with the processor 125 and other components of the computer system 200 via signal line 229.

Referring now to FIGS. 3A and 3B, depicted is a flowchart of an example method 300, according to some embodiments, for generating data that quantitatively describes areas for improving the performance of a set of ADAS systems, according to some embodiments. The set of ADAS systems may be sufficient to render a vehicle an HAV.

In some embodiments, one or more of the steps described herein for the method 300 may be executed by one or more reconstruction clients and one or more reconstruction modules.

At step 301, sensor data is collected and used to construct a sensor data log. This step may be completed by a reconstruction client of a vehicle which is an HAV.

At step 303, the sensor data log is transmitted to a reconstruction module via a network.

At step 305, a sensor data structure is constructed based one or more sensor data logs received from one or more vehicles.

At step 307, one or more sensor data logs (and, in some embodiments, the static environment data 171) are converted into high resolution temporal maps using one or more of the following: one or more sensor fusion techniques; one or more interpolation techniques; and one or more sensor fusion techniques and/or one or more interpolation techniques which are modified or enhanced using external data describing the geometry of the real world roadways (e.g., the geometry data 299). The output of step 307 is the simulation data which corresponds to the one or more sensor data logs (and, in some embodiments, the static environment data 171). Although one or more high resolution temporal maps are generated based on the sensor data logs (and, in some embodiments, the static environment data 171), a copy of the sensor data logs themselves (and, in some embodiments, the static environment data 171) are maintained for later use. In some embodiments, each of the sensor data logs used in step 307 (and, in some embodiments, the static environment data 171) is provided by the same vehicle or a plurality of vehicles each having the same vehicle make, model and trim level. Step 307 is described in more detail below according to some embodiments with reference to FIG. 4.

At step 308, the simulation data and the vehicle model data are provided as inputs the simulation application.

In some embodiments, the static environment data 171 is also provided as an input at step 308. In this way, the simulation provided by the simulation application includes the one or more static objects described by the static environment data 171.

In some embodiments, the simulations provided by the simulation application also include variables which are described by the sensor data logs (e.g., one or more measurements which are described by the sensor data 191).

At step 309, the simulation application is executed to provide a set of simulations for a vehicle design which corresponds to the vehicle model data and the vehicle which provided the one or more sets of vehicle data logs.

Referring now to FIG. 3B. At step 315, as the set of simulations are running, the reconstruction module monitors there execution and is operable to intervene in the set of simulations as they are executing. During this intervention, the reconstruction module may modify the execution of the set of simulations to attempt to reconstruct known events (a described by the one or more sensor data logs) and restart the executions to identify whether known outcomes occur. In this way the reconstruction module is operable to ensure that the set of simulations remain realistic.

At step 317, data resulting from running the set of simulations are analyzed. Data that may be of interest to the one or more human engineers is automatically tagged. This tagged data is the execution data and may further be analyzed to generate the review data.

Referring now to FIG. 4A, depicted is flowchart of an example method which is executed for step 307 of FIG. 3A according to some embodiments.

At step 401, point cloud data describing one or more temporal point clouds is generated based on the one or more sensor data logs.

At step 403, roadway environment model data describing one or more road geometries for a virtual (or simulated) version of the roadway environment described by the one or more sensor data logs is determined based on the GPS data (or GPS tags) included in the one or more sensor data logs.

At step 405, the shape of the one or more point clouds described by the point cloud data is modified based on the roadway environment model data; analyze the geometry data describing the known road geometries for the specific roadway environment described by the one or more sensor data logs to identify ways to modify the road geometries for the virtual or simulated version of the real-world roadways described by the roadway environment model data so that they are more accurate.

At step 407, the roadway environment model data is updated based on the geometry data.

At step 409, the shape of the one or more point clouds is modified based on the updated roadway environment model data.

At step 411, the point cloud data is converted into mesh data describing one or more polygon and triangle mesh models which describe the road geometry and the dynamic objects within one or more scenes of the simulation provided by the simulation data which is generated at step 413.

At step 413, the simulation data is built based on the mesh data.

Referring now to FIG. 5, depicted is a graphical user interface 500 including a simulation 130A of a recorded collision which occurred in the real-world for a real-world vehicle, and is described by a sensor data log 197 for that vehicle, and two simulations, 130B, 130N based on the sensor data log but testing different variations for the set of ADAS systems for the vehicle, according to some embodiments. For the simulation 130B, the set of ADAS systems are configured conservatively relative to the set of ADAS systems of simulation 130A and simulation 130N. For the simulation 130N, the set of ADAS systems are configured aggressively relative to the set of ADAS systems of simulation 130B and 130A.

In some embodiments, the vectors as shown in FIG. 5 illustrate, among other things, the direction of objects in FIG. 5.

Referring now to FIG. 6, depicted is graphical user interface 600 including an example of the execution data according to some embodiments. The execution data depicted in this graphical user interface 600 corresponds to the simulations 130A, 130B, 130N of FIG. 5.

Referring now to FIG. 7, depicted is a graphical user interface 700 including an example of the review data according to some embodiments. The review data depicted in this graphical user interface 700 corresponds to the simulations 130A, 130B, 130N of FIG. 5 and the execution data of FIG. 6.

Accordingly, the reconstruction module automatically generates realistic driving test cases using one or more sensor data logs gathered from real-world vehicles operating on real-world roadways. The test cases (e.g., simulations 130B, 130N) provide a means to obtain empirical evidence of improvements or areas of concern for the operation of one or more sets of ADAS systems for a vehicle which is an HAC. The analytics provided by the review data and the execution data enable humans (e.g., consumers and engineers) to make more knowledgeable decisions about different sets of ADAS systems, and variations of the ADAS systems included in the sets of ADAS systems, in real-world driving scenarios. An advantage of the functionality provided by the reconstruction module is that it makes it possible to acquire quantitative data about the relative performance of different sets of ADAS systems, and variations of the ADAS systems included in the sets of ADAS systems, without having to deploy real-world vehicles which are modified to include these different sets of ADAS systems, and variations of the ADAS systems included in the sets of ADAS system. In this way the simulations (such as those shown in FIG. 5) are used to generate quantitative data (such as that shown in FIGS. 6 and 7) which can then be used and reused to test multiple systems simultaneously to prove or disprove the reliability of different sets of ADAS systems, and variations of the ADAS systems included in the sets of ADAS system, in terms of real-recorded driving scenarios.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present embodiments can be described above primarily with reference to user interfaces and particular hardware. However, the present embodiments can apply to any type of computer system that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present embodiments of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some preferred embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method for improving a performance of a set of Advanced Driver Assistance Systems (“ADAS systems”) included in a vehicle design for a Highly Autonomous Vehicle (“HAV”), the method comprising:
generating simulation data based on a sensor data log generated by the HAV;
providing the simulation data, vehicle model data and ADAS model data as inputs to a simulation application, wherein the vehicle model data describes the vehicle design for the HAV and the ADAS model data describes one or more variations for the set of ADAS systems included in the vehicle design for the HAV;
executing, by a processor, the simulation application based on the inputs to provide a set of simulations which are configured to test the one or more variations for the set of ADAS systems included in the vehicle design for the HAV in one or more realistic driving scenarios which are described by the sensor data log, wherein each simulation included in the set of simulations tests a different variation for the set of ADAS systems;
analyzing, by the processor, operation of the different variations for the set of ADAS systems in the set of simulations to automatically generate, without an input to do so, review data that quantitatively describes one or more areas for improving the operation of the set of ADAS systems included in the vehicle design for the HAV; and
outputting a graphical user interface that displays the review data.

2. The method of claim 1, wherein the sensor data log includes one or more measurements recorded by an onboard sensor of the HAV.

3. The method of claim 1, wherein the sensor data log describes a relative position of the HAV and one or more objects within a real-world roadway environment that includes the HAV.

4. The method of claim 1, wherein the sensor data log describes an operation of the set of ADAS systems in response to one or more objects within a real-world driving scenario experienced by the HAV, wherein the set of ADAS systems are included in the vehicle design such that they are present in the HAV during the real-world driving scenario.

5. The method of claim 4, wherein set of simulations virtually recreate the real-world driving scenario so that an operation of the one or more variations for the set of ADAS systems is determined and measured by the set of simulations.

6. The method of claim 5, wherein the review data quantitatively describes the operation of the set of ADAS systems that are present in the HAV during the real-world driving scenario relative to the operation of the one or more variations for the set of ADAS systems included in the vehicle design for the HAV.

7. The method of claim 5, wherein the driving scenarios included in the set of simulations are realistic because they substantially recreate the real-world driving scenario which is described by the sensor data log.

8. The method of claim 5, further comprising analyzing the set of simulations to ensure that the driving scenarios included in the set of simulations substantially recreate the real-world driving scenario described by the sensor data log.

9. A system for improving a performance of a set of Advanced Driver Assistance Systems (“ADAS systems”) included in a vehicle design for a Highly Autonomous Vehicle (“HAV”), the system comprising:
a processor; and
a non-transitory memory storing computer code which is operable, when executed by the processor, to cause the processor to perform steps comprising:
generating simulation data based on a sensor data log generated by the HAV;
providing the simulation data, vehicle model data and ADAS model data as inputs to a simulation application, wherein the vehicle model data describes a vehicle design for the HAV and the ADAS model data describes one or more variations for the set of ADAS systems included in the vehicle design for the HAV;
executing the simulation application based on the inputs to provide a set of simulations which are configured to test the one or more variations for the set of ADAS systems included in the vehicle design for the HAV in one or more realistic driving scenarios which are described by the sensor data log, wherein each simulation included in the set of simulations tests a different variation for the set of ADAS systems; and
analyzing operation of the different variations for the set of ADAS systems in the set of simulations to automatically generate review data that quantitatively describes one or more areas for improving the operation of the set of ADAS systems included in the vehicle design for the HAV.

10. The system of claim 9, wherein the sensor data log includes one or more measurements recorded by an onboard sensor of the HAV.

11. The system of claim 9, wherein the sensor data log describes a relative position of the HAV and one or more objects within a real-world roadway environment that includes the HAV.

12. The system of claim 9, wherein the sensor data log describes an operation of the set of ADAS systems in response to one or more objects within a real-world driving scenario experienced by the HAV, wherein the set of ADAS systems are included in the vehicle design such that they are present in the HAV during the real-world driving scenario.

13. The system of claim 12, wherein set of simulations virtually recreate the real-world driving scenario so that an operation of the one or more variations for the set of ADAS systems is determined and measured by the set of simulations.

14. The system of claim 13, wherein the review data quantitatively describes the operation of the set of ADAS systems that are present in the HAV during the real-world driving scenario relative to the operation of the one or more variations for the set of ADAS systems included in the vehicle design for the HAV.

15. The system of claim 13, wherein the driving scenarios included in the set of simulations are realistic because they substantially recreate the real-world driving scenario which is described by the sensor data log.

16. The system of claim 13, further comprising analyzing the set of simulations to ensure that the driving scenarios included in the set of simulations substantially recreate the real-world driving scenario described by the sensor data log.

17. A computer program product for improving a performance of a set of Advanced Driver Assistance Systems (“ADAS systems”) included in a vehicle design for a Highly Autonomous Vehicle (“HAV”), the computer program product comprising a non-transitory memory storing computer-executable code that, when executed by a processor, causes the processor to:
generate simulation data based on a sensor data log generated by a HAV;
provide the simulation data, vehicle model data and ADAS model data as inputs to a simulation application, wherein the vehicle model data describes a vehicle design for the HAV and the ADAS model data describes one or more variations for the set of ADAS systems included in the vehicle design for the HAV;
execute the simulation application based on the inputs to provide a set of simulations which are configured to test the one or more variations for the set of ADAS systems included in the vehicle design for the HAV in one or more realistic driving scenarios which are described by the sensor data log, wherein each simulation included in the set of simulations tests a different variation for the set of ADAS systems; and
analyze operation of the different variations for the set of ADAS systems in the set of simulations to automatically generate review data that quantitatively describes one or more areas for improving the operation of the set of ADAS systems included in the vehicle design for the HAV.

18. The computer program product of claim 17, wherein the sensor data log includes one or more measurements recorded by an onboard sensor of the HAV.

19. The computer program product of claim 17, wherein the sensor data log describes a relative position of the HAV and one or more objects within a real-world roadway environment that includes the HAV.

20. The computer program product of claim 17, wherein the sensor data log describes an operation of the set of ADAS systems in response to one or more objects within a real-world driving scenario experienced by the HAV, wherein the set of ADAS systems are included in the vehicle design such that they are present in the HAV during the real-world driving scenario.
